(19) United States
(12) Patent Application Publication
(10) Pub. No.: US 2021/0390305 A1
(43) Pub. Date: Dec. 16, 2021

(54) METHOD AND APPARATUS FOR PROVIDING ANNOTATIONS IN AUGMENTED REALITY

(71) Applicants: Asa MacWilliams, Fürstenfeldbruck (DE); Peter Schopf, Erlangen (DE); Sebastian Fey, Erlangen (DE); Lucia Grom-Baumgarten, Stuttgart (DE); Anna Schröder, Erlangen (DE); Felix Winterhalter, Erlangen (DE)

(72) Inventors: Asa MacWilliams, Fürstenfeldbruck (DE); Peter Schopf, Erlangen (DE); Sebastian Fey, Erlangen (DE); Lucia Grom-Baumgarten, Stuttgart (DE); Anna Schröder, Erlangen (DE); Felix Winterhalter, Erlangen (DE)

(21) Appl. No.: 17/282,272

(22) PCT Filed: Jul. 3, 2019
(86) PCT No.: PCT/EP2019/067829

§ 371 Date: Apr. 1, 2021

(30) Foreign Application Priority Data
Oct. 4, 2018 (DE) 10 2018 217 032.0

(51) Int. Cl. G06K 9/00; G06T 19/00; G06F 30/12; G06N 3/02

(52) U.S. Cl. CPC G06K 9/00671; G06N 3/02; G06F 30/12; G06T 19/006

(57) ABSTRACT

A method and system for providing annotations related to a location or related to an object in augmented reality, AR. The method includes retrieving by a client device of a user a candidate list, CL, of available augmented reality bubbles, ARB, for the location and/or object in response to a query, Q, based on an approximate geolocation of the client device and/or based on user information data; selecting at least one augmented reality bubble, ARB, from the retrieved candidate list, CL, of available augmented reality bubbles; loading by the querying client device from a database a precise local map and a set of annotations for each selected augmented reality bubble, ARB, and accurate tracking of the client device within the selected augmented reality bubble, ARB, using the loaded precise local map of the respective augmented reality bubble, ARB, to provide annotations in augmented reality at exact positions of the tracked client device.

### CROSS REFERENCE TO RELATED APPLICATIONS

This present patent document is a § 371 nationalization of PCT Application Serial Number PCT/EP2019/067829 filed on Jul. 3, 2019, designating the United States, which is hereby incorporated in its entirety by reference. This patent document also claims the benefit of DE 102018217032.0 filed on Oct. 4, 2018 both are which are also hereby incorporated in their entirety by reference.

### BACKGROUND

Augmented reality (AR) provides an interactive experience to a user in a real-world environment. Objects that reside in the real-world environment are augmented by computer-generated information. The displayed overlaid information may be interwoven in the augmented reality with the physical real-world such that it is perceived by the user as an immersive aspect of the real environment. Augmented reality may be used to enhance natural environments or situations and offer perceptually enriched experiences to the user or operator. With the help of advanced augmented reality technologies, information about the surrounding real-world environment of the user may become interactive and may be manipulated by the user. In augmented reality, information about the environment and its objects is overlaid on the real-world. The displayed information may be virtual or real, e.g., allowing to perceive other real-sensed or measured information such as electromagnetic radio waves overlaid in exact alignment to where they actually are in space. Augmentation techniques are typically performed in real time and in a semantic context with environmental elements or objects.

In many use cases, it is necessary to place augmented reality annotations relative to a specific location or object in the physical real-world. Other users later wish to retrieve, view or edit this information when they are near the respective place or object.

Many different approaches exist for creating augmented reality content and later retrieving the augmented reality content. The conventional approaches include marker-based augmented reality where an augmented reality content is created in a three-dimensional graphics programming environment and anchored to a two-dimensional visual marker. The augmented reality content is then retrieved when the two-dimensional visual marker is inside of a camera of a client device handled by a user. Marker-based augmented reality may be used for augmented reality marketing apps, for example to place three-dimensional models on top of a magazine advertisement.

Another conventional approach is object-based augmented reality. Augmented reality content is created in a three-dimensional graphics programming environment and then anchored to a three-dimensional computer-aided design, CAD, data model. The augmented reality content is retrieved when the real object is detected by a client device using a model-based tracking approach. The object-based augmented reality is often used for maintenance applications in an industrial environment.

Another conventional approach is georeferenced augmented reality. The augmented reality content is generated and then retrieved in a geographically referenced content.

A further conventional approach is to place holograms that are three-dimensional models within an augmented environment that a client device of a user may recognize. Later, when another user uses the same client device in the same place, a HoloLens may recognize the place based on the three-dimensional reconstruction of the environment and show the hologram at the same place.

Augmented reality annotations are mostly related to a specific place (location) and/or object (thing) in the physical world. The geolocation of a client device is conventionally performed by a geolocation detection or determination unit integrated in the client device such as a GPS receiver receiving GPS satellite signals from GPS satellites to determine a current position of the client device. However, the geolocation provided by a conventional geolocation detection unit is in many applications not sufficiently accurate and exact. For example, in a technological environment such as a factory including machines with complex subcomponents, the conventional geolocation does not allow to provide annotations to a user at exact positions. Moreover, the geolocation detection units may not work indoors so that they cannot provide geolocation or the exact position of the client device with sufficient precision within a building such as a factory.

### BRIEF SUMMARY AND DESCRIPTION

The scope of the present invention is defined solely by the appended claims and is not affected to any degree by the statements within this summary. The present embodiments may obviate one or more of the drawbacks or limitations in the related art.

Embodiments provide a method and apparatus for providing annotations precisely at exact positions.

Embodiments provide a method for providing annotations related to a location or related to an object in augmented reality. The method includes: retrieving by a client device of a user a candidate list of available augmented reality bubbles for the location and/or object in response to a query based on an approximate geolocation of the client device and/or based on user information data, selecting at least one augmented reality bubble from the retrieved candidate list of available augmented reality bubbles, loading by the querying client device from a database a precise local map and a set of annotations for each selected augmented reality bubble and performing accurate tracking of the client device within the selected augmented reality bubble using the loaded precise local map of the respective augmented reality bubble to provide annotations in augmented reality at exact positions of the tracked client device.

The annotations provided by the method may assist a user to perform actions at exact positions and increases the accuracy of those actions.

In an embodiment, the selection of at least one augmented reality bubble from a retrieved candidate list of available augmented reality bubbles may be performed automatically.

In an embodiment, the selection of at least one augmented reality bubble from the retrieved candidate list of available augmented reality bubbles includes capturing images and/or sounds of the client device's environment, processing the captured images and/or captured sounds to extract tags compared with predefined bubble identification tags associated with the augmented reality bubbles of the retrieved candidate list and determining relevant augmented reality bubbles of the retrieved candidate list depending on the comparison results.

In an embodiment, the selection of at least one augmented reality bubble from the retrieved candidate list of available augmented reality bubbles may be performed in response to a user input command selecting an augmented reality bubble on the basis of names of available augmented reality bubbles displayed on a display of a user interface of the client device to the user.

In an embodiment, the local map loaded by the client device includes a local feature map, for example a SLAM (simultaneous location and mapping) map and/or a computer-aided design, CAD, model of an object within the selected augmented reality bubble.

In an embodiment, the approximate geolocation of the client device is detected by a geolocation detection unit of the client device.

In an embodiment, the geolocation detection unit of the client device is configured to determine the approximate geolocation of the client device in response to signals received by the geolocation detection unit from external signal sources including GPS satellites and/or WiFi stations.

In an embodiment, the annotations of the tracked exact current position of the client device are output by a user interface of the client device to a user or operator.

In an embodiment, the annotations include static annotations including text annotations, acoustic annotations and/or visual annotations (including VR experiences) related to a location and/or related to a physical object.

In an embodiment, the annotations include static annotations including text annotations, acoustic annotations and/or visual annotations (including VR experiences) related to the augmented reality bubble as such.

The annotation is not linked to a specific location or a specific physical object within the augmented reality bubble. Instead, the annotation is linked to the entire augmented reality bubble; in other words, the annotation is linked to the whole augmented reality bubble as such. In these cases that the augmented reality bubble corresponds to a (physical) room, the present embodiment may also be referred to as “post to room”. An advantage of linking the annotation to, for example, the whole room is that the placement of the annotation is simplified and also works if there are problems with scanning the room.

In another alternative, the annotations may also include haptic information related to a specific object. This alternative could be specifically relevant with regard to the use of data gloves.

The provision of haptic information allows the user a simplified and more intuitive interaction with digital content. The provision and retrieval of haptic information is advantageously carried out with a data glove, that records the respective information.

In an embodiment, the annotations include links to sources providing static annotations and/or dynamic live annotations including data streams.

In an embodiment, the annotations are associated with different digital annotation layers selectable and/or filtered according to user information data including user access rights and/or user tasks.

In an embodiment, each augmented reality bubble is represented by a dataset stored in a database of a platform. The dataset includes: a bubble name of the augmented reality bubble, an anchor point attached to a location and/or attached to an object and including global coordinates of a global coordinate system, a precise local spatial map including within a sphere of the augmented reality bubble tracking data used for accurate tracking of client devices within the sphere and including local coordinates of a local coordinate system around the anchor point of the augmented reality bubble, annotations related to locations and/or objects within the sphere of the augmented reality bubble and bubble identification tags used to identify the augmented reality bubble by comparison with extracted tags.

In an embodiment, the bubble identification tags of an augmented reality bubble dataset include detectable features within the sphere of the augmented reality bubble including textual features, acoustic features and/or visual features within an environment of the augmented reality bubble's sphere.

In an embodiment, images and/or sounds of the client device's environment are captured by sensors of the client device and processed by a tag recognition algorithm or by a trained neural network to classify them and to extract tags used for comparison with predefined bubble identification tags.

In an embodiment, several augmented reality bubbles are pooled together in one meta-augmented reality bubble and the augmented reality bubbles form part of the candidate list.

The augmented reality bubbles adhering to one meta-augmented reality bubble (in short: meta bubble) may be provided with internal markers. A meta bubble may include a precise local map covering all augmented reality bubbles that are pooled in the meta bubble.

In an example, a meta bubble may correspond to a conference building. In this example, the meta bubble may include a plurality of augmented reality bubbles adhering to the meta bubble. Each augmented reality bubble corresponds to one conference room of the conference building. If a user arrives at a certain conference room of the conference, the user is manually or automatically located precisely and may receive respective annotations belonging to the specific room in which the user is present.

A meta bubble may include terms of use that govern the access rights to all augmented reality bubbles pooled in the meta bubble. This may prevent the inner structure of a building, e.g., the number and labels of its rooms, from being recognized from outside.

In an embodiment, one of the available augmented reality bubbles is linked to the position of a device of the user. The device may for example be a smartphone of the user.

The augmented reality bubble may also be referred to as a “free float bubble” or a “user bubble”. The user has its own personal bubble that the user is able to open at any time because the bubble is linked to the user's smartphone and thus follows the user wherever the user goes. The user bubble may also be opened in case that the user is already located in another bubble (“bubble-in-bubble” scenario).

In an alternative (“free float bubble”), the annotations in the user bubble may only be seen and edited by the user to which it belongs to. In this case, the user bubble may be seen as a personal clipboard of the user.

In an alternative (“user bubble”), the annotations in the user bubble may also be visible and editable by other users being located in or near the user bubble. In that case, the user may leave notes in their user bubble that the user would like to share with others.

By free float or user bubbles, users are allowed to transport and access information at any time at any place in an uncomplicated manner. Further, the edition and interaction of the information is optimized.

The free float and user bubbles may require merging of location data (geo-tracking data) with the data obtained from a location determination device to correctly link the annotations of the free float and user bubbles with the position of the respective user (for example, a smartphone).

For user bubbles, the communication between devices of plural persons is needed, e.g., in a common space that is also referred to as “worldspace”.

In an embodiment, the query is input via a user interface of the client device and supplied via a local and/or global network to a server including a search engine that in response to a received query determines augmented reality bubbles available at the detected approximate geolocation of the querying client device and returns the candidate list of available augmented reality bubbles back to the querying client device.

For example, the client device may also transmit sensor data to the server when transmitting its approximate geolocation to the server.

As an example, the client device not only sends GPS information, but also, for example, small amounts of sensor data (audio, video, etc.) to the server. The server may then compare the received sensor data with existing data of the respective augmented reality bubble. The amount of data sent from the bubble to the server may be reduced, thus energy consumption of the client device is reduced, and battery life of the client device may be prolonged. Further, display of complex holograms may be provided.

In an embodiment, the accurate tracking of the client device within a sphere of a selected augmented reality bubble using the loaded precise local map of the respective augmented reality bubble is based on low level features extracted from images and/or sounds captured by sensors of the client device.

In an embodiment, the annotations related to a location and/or to an object are created and/or edited and/or assigned to a specific digital layer by a user by a user interface of a client device of the respective user.

The access rights to specific layers may, for example, be stored in the user-defined settings. The access rights may be viewed and edited e.g., in the application that provides the annotated augmented reality bubbles to the user. Safety settings such as password protection of the settings may be provided. Access to an augmented reality bubble may be provided via weblink or similar providers.

In an embodiment, the objects include physical objects including immobile objects located at fixed locations in the real-world environment or mobile objects movable in the real-world environment and including variable locations.

In an embodiment, the layout of an augmented reality bubbly adhering to a specific company may adapt to the corporate identity (corporate design) of that design. This applies, for example, to the user interface, the layers or the annotations being displayed in the respective bubble.

Embodiments provides a system for providing annotations related to locations and/or related to objects in augmented reality.

The system includes client devices connected via a local network and/or a wide area network to a server configured to retrieve in response to a query received from a querying client device of a user a candidate list of available augmented reality bubbles based on an approximate geolocation of the querying client device and/or based on user information data and to return the retrieved candidate list to the querying client device of the user for selection of at least one augmented reality bubble from the returned candidate list. A precise local map and a set of annotations for each selected augmented reality bubble is loaded from a database of the server by the client device used for tracking of the client device within the selected augmented reality bubble and to provide in augmented reality annotations at exact positions of the tracked client device.

In an embodiment of the system, the client device includes a processor that is configured to process automatically captured images and/or captured sounds of the client device's environment to extract automatically tags compared with predefined tags associated with available augmented reality bubbles wherein the extracted tags are compared with predefined bubble identification tags associated with the augmented reality bubbles of the retrieved candidate list to determine automatically the most relevant augmented reality bubble from the retrieved candidate lists.

### BRIEF DESCRIPTION OF THE FIGURES

FIG. 1 depicts a schematic block diagram for illustrating an embodiment of a method and apparatus.

FIG. 2 depicts a flowchart of an embodiment of a method for providing annotations.

FIG. 3 depicts a signaling diagram for illustrating an embodiment of a method and apparatus.

FIG. 4 depicts a schematic diagram for a use case for a method and apparatus according to an embodiment.

FIG. 5 depicts a schematic diagram for a use case for a method and apparatus according to an embodiment.

### DETAILED DESCRIPTION

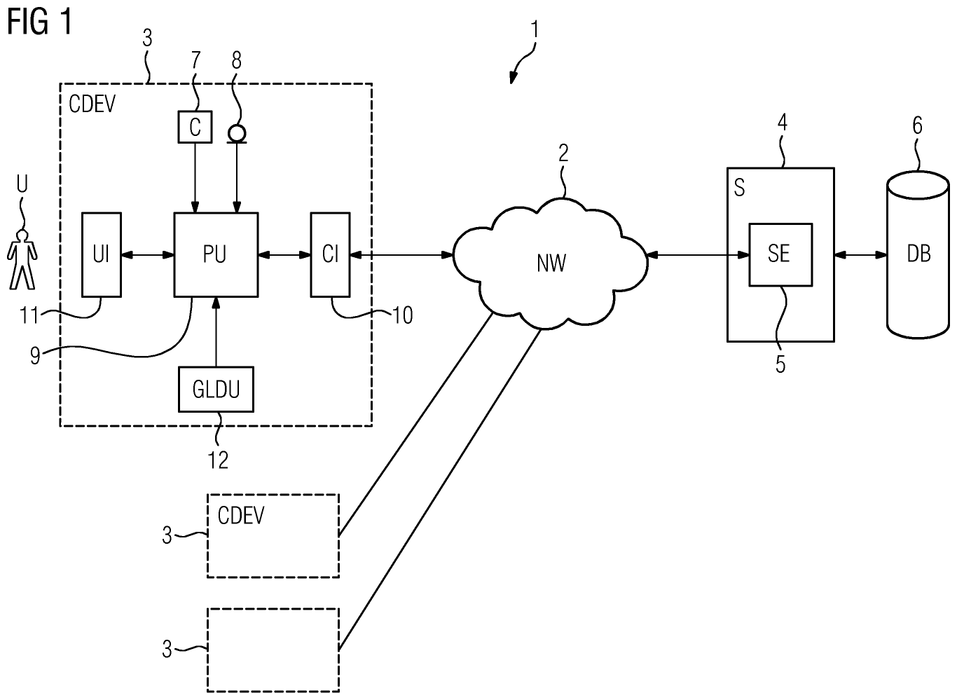

As may be seen from the block diagram of FIG. 1, embodiments provide a system 1 for providing annotations related to locations and/or related to an object in augmented reality. The system 1 includes a network cloud 2 including local networks and/or wide area networks that connect client devices 3 with at least one server 4 including a search engine 5. The search engine 5 of the server 4 may have access to a central database 6 or distributed databases 6. The system 1 may include a plurality of different client devices 3 that are connected directly or indirectly (router, edge device) via wired or wireless links to the network cloud 2. The augmented reality client devices 3 may include for example smartphones, tablets or client devices with head-mounted displays. The client devices 3 include wide area network connectivity. The client device 3 may include sensory hardware of sensors, for example a camera 7 and/or a microphone 8 as illustrated in FIG. 1. The sensors 7, 8 of the client device 3 may provide a processing unit 9 of the client device 3 with sensor data. The camera 7 of the client device 3 is configured to capture images of the client device's environment. The microphone 8 is configured to capture sounds of the environment of the client device 3. The client device 3 includes a communication interface 10 to connect the client device 3 with the network cloud 2 via a wireless or wired datalink. The client device 3 further includes a user interface 11 to display information to a user U and/or to receive user input commands.

In FIG. 1, the client device 3 further includes a geolocation detection unit 12. The geolocation detection unit 12 provides an approximate geolocation of the client device 3. The geolocation detection unit 12 of the client device 3 is configured to determine the approximate geolocation of the client device 3 in response to signals received by a receiver of the client device 3 from external signal sources. The external signal sources may include GPS satellites sending GPS satellite signals to the geolocation detection unit 12 of the client device 3 and/or WiFi stations transmitting WiFi signals. The client device 3 may contain a GPS receiver, a WiFi-based or similar geolocation detection device 12. The geolocation detection unit 12 allows the client device 3 to determine its position within a certain (relatively low) accuracy of approximately 5 meters outdoors and 50 meters indoors. The geolocation detection unit 12 may be integrated into the client device 3 as depicted in FIG. 1 or in another device that is connected to the client device 3. For example, if the client device 3 does not include a geolocation detection unit, it may be tethered to another device including a geolocation detection unit 12. This external device may be for example a smartphone operating as a mobile hotspot and including a GPS receiver.

The client device 3 includes a camera 7 capable of taking photographs or images of the environment that may be supplied to the processing unit 9 of the client device 3. The processing unit 9 includes at least one microprocessor that may in an embodiment run an image recognition algorithm for performing image recognition tasks. Alternatively, the images generated by the camera 7 of the client device 3 may also be sent via the network cloud 2 to the server 4 including a processor configured to perform the required image recognition task. In a similar manner, the sounds captured by the camera 8 may be either processed by a microprocessor integrated in the processing unit 9 of the client device or by a processor of the remote server 4. The client device 3 includes the camera 7, a screen and/or appropriate sensory hardware to enable augmented reality interaction with the user U. A memory of the client device 3 may include executable software that is capable of performing local SLAM (simultaneous location and mapping) for augmented reality. An example may include an Apple iPhone with ARKit 2 or Microsoft Hololens. The SLAM software may create a three-dimensional SLAM map of local optical features of the client device's environment or real-world and may save this map to the server 4. Furthermore, the software may be configured to retrieve a map of pre-stored features from the database 6 of the server 4 and use the retrieved features for precise tracking of the client device 3. The size of the local feature map LMAP may be limited to a certain three-dimensional area. This three-dimensional area or bubble may include in a possible implementation the size of approximately 10×10×10 meters. The size of the local map may correspond to the approximate size of different rooms within a building. The size of the local feature map LMAP may vary depending on the use case. In the system 1 as depicted in FIG. 1, the client device 3 is configured to display or output annotations in augmented reality AR via the user interface 11 to a user or operator U. The client device 3 may retrieve the annotations ANN from the server 4 and let the retrieved annotation be viewed and/or heard by the user U by the user interface 11. The annotations ANN may include speech (audio and speech-to-text), floating three-dimensional models such as arrows, drawings, photographs and/or videos captured by the client device 3 and/or other documents. The annotations may include static annotations and/or dynamic live annotations. The static annotations may in general include text annotations, acoustic annotations and/or visual annotations related to a location and/or related to an object. Annotations may also include links to sources providing static annotations or dynamic live annotations including data streams.

Annotations ANN may include data and/or data streams provided by other systems such as a SCADA system. In an embodiment, the client device 3 may be connected either via a local network to a local controller or edge device or via a cloud to a live IoT data aggregation platform. Annotations may contain links to live data streams, e.g., a chart from a temperature sensor that is located inside a machine or object. Annotations may be structured into logical digital layers L. A layer L is a group of annotations that are relevant to certain types of users U at certain times, for example maintenance information, construction information, tourist information or usage information. A user U may choose between different digital layers L of annotations to be displayed to the user via the user interface 11. The annotations are associated with different digital annotation layers L that may be selected by the user interface 11 that may be filtered using filtering algorithms. The selection of digital annotation layers may be performed on the basis of user information data including user access rights of the users and/or stored user tasks of the respective users. It is possible that a user may generate or create annotations connected to objects and/or locations and assign the created annotations to different digital layers L dependent on an intended use. In an embodiment, the user may manage access for other users to the respective digital layers L thus letting other users access the annotations they have created.

The different client devices 3 are connected via the network cloud 2 to at least one server 4 as shown in FIG. 1. The server 4 may include a cloud server or a local or edge server. The server 4 includes access to a database 6 to store data for the different clients. The database 6 may store augmented reality bubbles ARB s represented by corresponding datasets. A dataset of an augmented reality bubble ARB may include in a possible embodiment a bubble name of the respective augmented reality bubble, an anchor point attached to a location and/or attached to an object and including global coordinates of a global (worldwide) coordinate system. The dataset includes further a precise local spatial map such as a SLAM map including within a sphere of the augmented reality bubble ARB tracking data used for accurate tracking of client devices 3 within the sphere and including local coordinates of a local coordinate system around the anchor point of the augmented reality bubble. The local coordinates are accurate and precise. The local coordinate may indicate a location with a high accuracy of a few cm and even a few mm. The dataset includes annotations ANN related to locations and/or objects within the sphere of the augmented reality bubble and bubble identification tags used to identify the augmented reality bubble by comparison with extracted tags. The augmented reality bubble ARB includes depending on the technology a sphere or area or zone with a diameter of e.g., approximately 10 meters size. The size of an ARB may vary depending on the implemented technology and/or also the use case. It might cover a single room or a whole manufacturing floor in a building. The augmented reality bubble may have a spherical shape but also other geometrical shapes (e.g., cubic). The augmented reality bubble ARB may include a fixed or varying geographic location defined by its geolocation coordinates. The augmented reality bubble ARB may include a user-friendly name that has been entered by the user U that created the respective augmented reality bubble ARB. A typical name for an augmented reality bubble ARB may be for example “Machine Room 33”. The augmented reality bubble dataset stored in the database 6 includes further a spatial SLAM map generated by the client devices 3 to provide precise tracking. The dataset further includes references to additional information that allows client devices 3 to identify it more easily. For example, the augmented reality bubble dataset may include bubble identification tags BIT used to identify the augmented reality bubble by comparison with extracted tags. The bubble identification tags BITs may include for example textual information such as a room number that may be detected by a text recognition on photos captured by the camera 7 of the client device 3. The bubble identification tags BITs may further include for example a barcode ID or any other high-level features that may be detected using image recognition. The augmented reality bubble ARB further includes annotations ANN related to locations and/or objects within a sphere of the augmented reality bubble ARB. These include all data of the created annotations including text, audio, photos, videos, documents, etc. grouped within the logical digital layers L. In a possible embodiment, the server 4 includes the search engine 5 that receives queries Q from different client devices 3 via the cloud network 2. The queries Q may include the approximate geolocation of the querying client devices 3. The search engine 5 may determine on the basis of the received information contained in the received queries Q in which augmented reality bubbles ARBs the querying client devices 3 are currently in (or close to). In an embodiment, the server 4 may further include an image recognition functionality processes images uploaded by the different client devices 3.

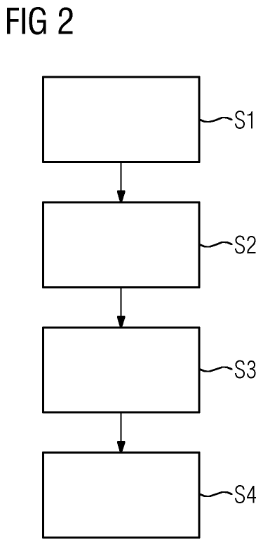

FIG. 2 depicts a flowchart of an embodiment of a method for providing annotations related to a location and related to an object in augmented reality AR.

In a first step S1, a candidate list CL of available augmented reality bubbles ARBs is retrieved by a client device 3 in response to a query Q based on an approximate geolocation of the client device 3 and/or based on user information data of a user handling the client device 3. The client device 3 of a user U may submit or send a query Q to the server 4 of the system 1 including a search engine 5 as depicted in FIG. 1. The query Q may include a determined or detected approximate geolocation of the respective querying client device 3. The search engine 5 has access to the database 6 to find available augmented reality bubbles ARBs related to the indicated geolocation and/or related to a specific object. A specific object specified in the query Q may include an immobile object located at a fixed position or a mobile object such as a vehicle including variable positions. A retrieved candidate list CL of available augmented reality bubbles ARBs is returned to the querying client device 3.

In a step S2, at least one augmented reality bubble ARB from the retrieved candidate list CL of available augmented reality bubbles is selected. The selection of augmented reality bubbles ARBs from the returned candidate list CL of available augmented reality bubbles may be performed either automatically and/or in response to user commands. In a possible embodiment, at least one augmented reality bubble ARB is selected from the retrieved candidate list CL by capturing images and/or sounds of the client device's environment and by processing the captured images or captured sounds to extract tags compared with predefined bubble identification tags associated with the augmented reality bubbles of the retrieved candidate list CL. Finally, relevant augmented reality bubbles ARBs of the retrieved candidate list are determined depending on the comparison results. Accordingly, the retrieved candidate list CL of available augmented reality bubbles is narrowed down on the basis of tags extracted from the captured images and/or captured sounds. In an embodiment, the candidate list CL of available augmented reality bubbles ARBs is displayed to a user via the user interface 11 of the client device 3 showing the names of the respective augmented reality bubbles ARBs. The user U may select several of the displayed augmented reality bubbles and input a corresponding user command for selecting required or desired augmented reality bubbles.

In a step S3, the querying client device 3 may load from the database 6 of the server 4 a precise local map such as a SLAM map as well as a set of annotations for each selected augmented reality bubble.

In a step S4, an accurate tracking of the client device 3 is performed within a selected augmented reality bubble ARB using the loaded precise local map of the respective augmented reality bubble to provide annotations in augmented reality AR via the user interface 11 at exact positions of the tracked client device 3.

A user U may activate a find bubble functionality on his client device 3. The client device 3 then determines the client device's approximate geolocation and supplies automatically a corresponding query Q to the server 4 to find augmented reality bubbles ARBs at the respective determined geolocation (approximate location of the client device 3). If there are more than one possible augmented reality bubbles ARBs within the accuracy range of the geolocation, the client device 3 may prompt the user U to point the camera 7 of the client device 3 at easily identifiable bubble identification tags such as pieces of text (e.g. a sign with a room number), barcodes (e.g. a machine serial number tag) or any other distinguishing visual high-level features of the environment such as a poster on a wall showing a specific picture such as a sliced orange. In a possible embodiment, the client device 3 may then send the captured images to the server 4 for image processing to provide refinement of the original geolocation-based query Q. The server 4 may extract for example text from the received images, e.g., Room 33.464 as the room number, 123472345 for a barcode or “Orange”. In an embodiment, the image recognition may also be performed by the processing unit 9 of the client device 3. In an embodiment, images and/or sounds of the client device's environment may be captured by sensors of the client device 3 and processed by a tag recognition algorithm or by a trained neural network to classify them and to extract tags used for comparison with predefined bubble identification tags stored in the database 6. From the extracted tags, a shorter candidate list CL of potential or available augmented reality bubbles may be returned to the querying client device 3. The client device 3 may then present via its user interface 11 a candidate list CL of possible augmented reality bubbles to the user U along with user-friendly names of the respective augmented reality bubbles and potentially identifying pictures. The user U may then select via the user interface 11 augmented reality bubbles inputting a user command. The selection process may be assisted by an automatic selection using the extracted tags. After having selected one or more of the augmented reality bubbles ARBs from the retrieved candidate list CL of available augmented reality bubbles, a local precise map for each selected augmented reality bubble ARB is automatically loaded by the client device 3 from the server 4 along with a set of annotations for each selected augmented reality bubble. The downloaded precise local maps such as SLAM maps and the associated annotations may be stored in a local memory of the client device 3. After download of the precise local map, the client device 3 may be automatically and accurately tracked within the selected augmented reality bubble using the loaded local map and provide annotations in augmented reality at exact positions of the tracked client device.

In an embodiment, if no augmented reality bubble ARB is found in the area of the user's client device 3, the user has the possibility to create a new augmented reality bubble. If other ARBs already exist, the user U has also the possibility to add additional ARBs. For example, the client device 3 may prompt the user U via the user interface 11 to generate an augmented reality bubble at the current location. A user U may activate a new bubble functionality via the user interface 11 of the augmented reality client device 3. The client device 3 determines by its geolocation detection unit 12 its current geolocation, for example approximate position, to give the user U a feedback if the determined geolocation is accurate enough to create an augmented reality bubble. Then, the client device 3 prompts the user U to take photographs or images of visually interesting elements or objects within the client device's environment such as room name, tags or serial numbers, posters, etc., that may be used to assist in disambiguating the different augmented reality bubbles later. The client device 3 may further prompt the user U to take some overview photos of the augmented reality bubble to be presented to other users of the platform. The user creating the augmented reality bubble may enter a unique user-friendly name of the augmented reality bubble ARB to be created. Then, the user U may walk around in the area of the augmented reality bubble giving the augmented reality client device 3 ample opportunity to create a detailed local feature map or SLAM map of the area. When the client device 3 has created a local feature map that is detailed enough, it informs the user U and uploads the local detailed feature map (SLAM map) and all other relevant data of the augmented reality bubble ARB to the server 4 that stores the data in the database 6. For each created augmented reality bubble, the database 6 may store a corresponding dataset including an augmented reality bubble name, an anchor point of the augmented reality bubble including local coordinates of a global coordinate system, a precise local spatial map (SLAM map), bubble identification tags that may be used for automatic identification of the created augmented reality bubble as well as annotations related to the created augmented reality bubble.

The augmented reality client device 3 may let the user U create new content from a created or already existing augmented reality bubble by selecting an “add annotation” functionality. This may be a simple as tapping on a screen of the user interface 11 or simply speaking to a microphone 8 of the client device 3. The new textual, acoustic or visual annotation is stored in the dataset of the augmented reality bubble ARB.

The user U may view content from different logical digital layers L. In a possible embodiment, once the user U has selected an augmented reality bubble ARB from the candidate list CL, the user U may view different layers L of content that are available in the selected augmented reality bubble ARB. For example, the augmented reality bubble with the name “Machine Room 33” selected manually or automatically may have a “building construction”, a “machine commissioning”, a “machine operation” and a “machine maintenance” logical layer L. For example, the particular user U may be only authorized to view and edit the “machine commissioning”, “machine operation” and “machine maintenance” layers and not the “building construction” layer. The user U may then select that he wishes to view only the “machine maintenance” and “machine commissioning” layers L. In an implementation the same augmented reality bubble, ARB, may be selected in different layers L, when the annotations differ for the different layers L (ARB-layer L-annotations). In another implementation an additional structure is provided where the user does first select the layer L and then gets the augmented reality bubbles, ARBs, including annotations in that layer L for selection of an augmented reality bubble (ARB) (layer L-ARB-annotation). For example, if a user U selects the layer “maintenance”, the user may have a unique set of ARBs and a layer-specific library of annotation objects (such as specific 3D objects).

Once the user U has selected at least one digital logical layer L, the user U may view content, for example annotations, that have been created by the user or other users U in the respective layer L. For this, the user U may look around with his augmented reality client device 3. All the annotations in the selected augmented reality bubble ARB and the selected digital layers L are represented visually to the user U by the user interface 11 of the user client device 3. For example, by tapping, air-tapping or glancing at a displayed annotation, the user U may view or hear additional information on a specific annotation, for example a movie annotation may be played to the user U.

In an embodiment, the client device 3 may include a mechanism to ensure that new information is added to correct digital layers L. This mechanism may let the user U choose whether the user U is currently editing the “machine commissioning” or “machine maintenance” layer L. Or, the mechanism may add all annotations to a “my new annotations” layer L at first, and then provides a possibility to move the annotation to other different digital layers L.

The user U may also add live annotations to an augmented reality bubble. For example, on an augmented reality client device 3 that may be formed by a smartphone, the user U may create a chart of information from sensors within a nearby machine or object (after having established a connection to this machine via some network or cloud connection). Once a user U has created this chart, the user U may share the created chart as a live annotation in the augmented reality bubble ARB. Later, other users U may see the created chart in the same place but with more current data. Accordingly, the annotations of an augmented reality bubble ARB may include both static annotations but also live dynamic annotations including links, for example datalinks to data sources providing dynamic live annotations including data streams, for example sensor data streams.

A user U may also create new additional layers L giving them a unique name such as “maintenance hints”. The user client device 3 may query the server 4 for names of existing digital layers L that are available for another augmented reality bubbles. If the desired layer L does not yet exist, the user U may create a new digital layer L.

A user U of a client device 3 may share content with other users of the platform or system 1. The client device 3 provides a user interface 11 that may provide the user U with the option to share layers L that the user has created in a specific augmented reality bubble with other users of the platform. Depending on the details of the role management system, that may be based on user groups, for example all maintenance workers may have access to the maintenance layer L in all augmented reality bubbles. Further, the user U may include different access rights for different logical layers L. Access rights may be defined for an entire digital layer L across all augmented reality bubbles or may be specific to a single augmented reality bubble. This concept provides a crowd creation with specific groups of interest providing content to specific topics, either open to all or with limited access for modification. The system 1 as depicted in FIG. 1 may further include besides the augmented reality devices 3 further devices including non-AR devices. The non-AR client devices may include for example computers or personal computers that let users to perform administrative tasks such as right management or bulk data import. It may also include placing data in specific geolocations such as from a BIM/GIS system or importing data from CAD models.

The system 1 provides further automatic content creation and update based on IoT platforms such as MindSphere and SCADA systems. The content of an augmented reality bubble might change in real time, e.g., with live annotations, that show data e.g., from SCADA systems or an IoT platform such as MindSphere.

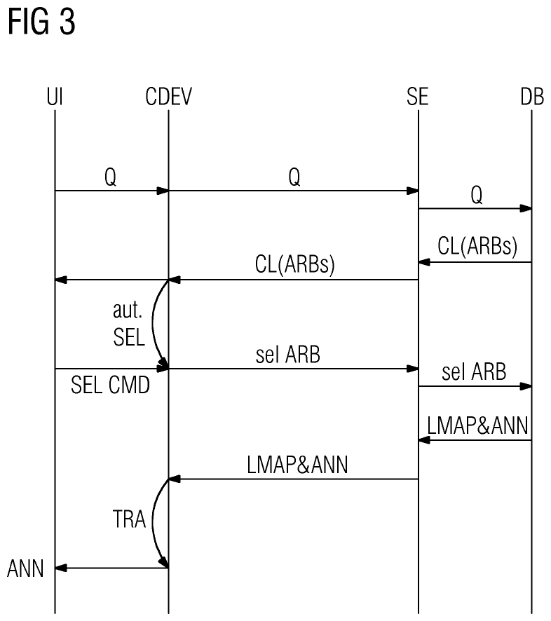

FIG. 3 depicts a signaling diagram to illustrate the retrieving of content including annotations by a user from a platform such as depicted in FIG. 1. As may be seen, a user may input a query Q by a user interface UI such as user interface 11. The client device 3 may forward the input query Q to a search engine (SE) 5 of a server 4 to retrieve a candidate list CL of available augmented reality bubbles ARB as shown in FIG. 3. A candidate list CL of available augmented reality bubbles is returned via the cloud network 2 back to the querying client device 3 as illustrated in FIG. 3. The candidate list CL of available augmented reality bubbles may be displayed via the user interface 11 to the user U for manual selection. The user U may select one or more available augmented reality bubbles by inputting a corresponding selection command (SEL CMD). For example, the user U may press displayed names of available augmented reality bubbles. Alternatively, the selection of the relevant augmented reality bubbles of the candidate list CL may also be performed automatically or semi-automatically based on extracted tags compared with predefined bubble identification tags. At least one selected augmented reality bubble (sel ARB) is returned to the search engine (SE) 5 that retrieves for the selected augmented reality bubble a precise local feature map (SLAM map) with a set of related annotations for the respective augmented reality bubble. The precise local feature map (LMAP) and the set of annotations ANN is returned to the querying client device 3 as shown in FIG. 3. Then, an accurate tracking (TRA) of the client device 3 within the selected augmented reality bubbles is performed using the downloaded precise local feature map (LMAP) of the augmented reality bubble ARB to provide annotations ANN in augmented reality AR at the exact positions of the tracked client device 3.

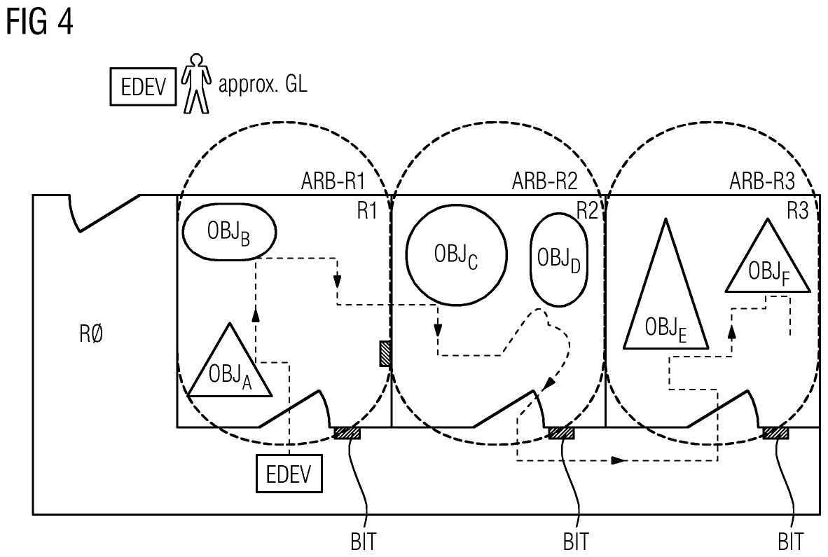

FIG. 4 depicts schematically a use case for illustrating the operation of the method and apparatus. In the use case, the user U carrying a client device 3 enters a building at a room R0. The client device 3 includes a geolocation determination unit such as a GPS receiver that allows to determine the approximate geolocation of the device 3 before entering the building. Based on the approximate geolocation (approx. GL) of the client device 3, the client device 3 of the user U gets a candidate list CL of available augmented reality bubbles ARBs for the respective location and/or for any object in response to a query Q. The retrieved candidate list CL of available augmented reality bubbles includes augmented reality bubbles in the vicinity of the approximate geolocation that may be preselected or filtered based on user information data concerning the user U, for example access rights and/or tasks to be performed by the user U. After having entered the building at room R0, the user U scans in the illustrated use case the environment in front of room R1 where a predefined bubble identification tag BIT may be attached showing the room number of room R1. From the display of the user interface 11 of the client device 3, the user U may see a list of available augmented reality bubbles such as ARB-R1, ARB-R2 and ARB-R3 for the different rooms R1, R2, R3 of the building. The different ARBs may or may not overlap. The borders of the ARB spheres may not be precisely aligned (as shown in FIG. 4) but may overlap or will be located apart. The user U may scan the bubble identification tag BIT at the entrance of the room to perform an automatic selection of the most relevant augmented reality bubble. In the given example, the augmented reality bubble for the first room R1 (ARB-R1) is automatically selected on the basis of the extracted tags and the predefined bubble identification tags. As soon as the augmented reality bubble ARB has been selected automatically or in response to a user command, a precise local feature map (SLAM map) is downloaded along with a set of annotations ANN to the client device 3 of the user U. The user U enters the room R1 and the movement of the user U and its client device 3 within the augmented reality bubble ARB-R1 is automatically and precisely tracked using the downloaded precise local feature map (SLAM map) to provide annotations ANN in augmented reality at the exact current positions of the tracked client device 3. In the example of FIG. 4, the client device 3 of the user U is first moved or carried to object OBJ_{A} to get annotations ANN for this object. Then, the user U along with the client device 3 moves to object OBJ_{B} to get annotations for this object. Later on, the user U moves on to the second room R2 of the building to inspect object OBJ_{C} and object OBJ_{D}. A handover mechanism may be implemented if a client device 3 moves from one augmented reality bubble such as augmented reality bubble ARB-R1 for room R1 to another augmented reality bubble such as augmented reality bubble ARB-R2 for room R2 as illustrated in FIG. 4. During the movement within the rooms R, the camera 7 of the client device 3 remains switched on or activated to detect and extract tags associated with augmented reality bubbles. Before entering the second room R2, a camera 7 may extract tags associated with the second augmented reality bubble ARB-R2 that may be attached to a shield or plate indicating the room number of the second room R2. The user U along with the client device 3 may leave the second room R2 and finally enter the last room R3 to inspect objects OBJ_{E} and OBJ_{F}. The different objects in FIG. 4 may include any kind of objects, for example machines within a factory. The objects may also be other kinds of objects such as art objects in an art gallery. The annotations ANN provided for the different objects may include static annotations but also live annotations including data streams provided by sensors of objects or machines.

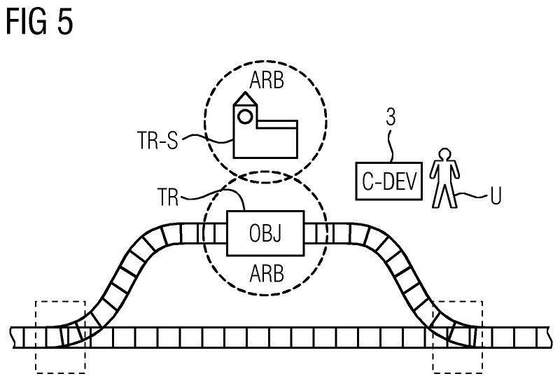

FIG. 5 illustrates a further use case where the method and system 1 may be implemented. In the example of FIG. 5, a first augmented reality bubble ARB is related to a fixed object such as a train station and another augmented reality bubble ARB is related to a mobile object such as a train that entered the train station TR-S or stands close to the railway station. A user U standing with his client device 3 close to the train TR may get the augmented reality content of both augmented reality bubbles, for example the augmented reality bubble ARB of the train station TR-S and the augmented reality bubble ARB of the train TR standing in the train station. For example, the user U may be informed which train TR is currently waiting in which train station TR-S.

An augmented reality bubble ARB of the system 1 is a spatial area (indoors or outdoors) including a predetermined size (e.g., approximately 10 meters wide) surrounding a particular physical location and/or a physical object. The object OBJ may be a static object such as a train station TR-S but also a mobile object such as a train TR. Another example may include a substation building for electrifying railways, poles that are installed or will be installed along a railway track (on a future location), a gas turbine within a gas power plant, a pump station for oil and gas transport. An augmented reality bubble ARB contains a set of annotations ANN that may refer to real-world objects within a sphere of the augmented reality bubble. The annotations ANN related to the location and/or object of an augmented reality bubble ARB may be created and/or edited and/or assigned to specific digital layers L by a user U by a user interface UI of a client device 3 of the respective user. The objects OBJ may include physical objects including immobile objects located at a fixed location in the real-world environment or mobile objects movable in the real-world environment and including variable locations. The accurate tracking of the client device 3 within a sphere of a selected augmented reality bubble ARB including the downloaded precise local feature map of the respective augmented reality bubble may be based in an embodiment on low-level features extracted from images and/or sounds captured by sensors of the client device 3. The low-level features may be for example features of an object surface and/or geometrical features such as edges or lines of an object. Annotations ANN may be created by users U and may include for example three-dimensional models, animations, instruction documents, photographs or videos. Annotations ANN may also include datalinks to live data sources such as sensors, for example sensors of machines within a factory. The system 1 provides a transition from a rough inaccurate tracking based on geolocation to an accurate local tracking on the basis of a downloaded precise local feature map, for example a SLAM map. The system 1 provides a scalable data storage for simultaneous editing by multiple users U. The system 1 allows to place georeferenced holograms by performing a drag-and-drop operation of the holograms into a map of a backend and/or browser-based system. The system 1 provides an integration of IoT platform data into georeferenced augmented reality content, providing real-time status updates and visualization of data or data streams (live annotations). The system 1 combines rough global tracking (such as tracking on the basis of GPS coordinates) with strong accurate tracking client devices using SLAM maps. The system 1 further provides on-site authoring of annotations ANN related to georeferenced augmented reality bubbles ARBs as well as adjustment of augmented reality content. The system 1 provides precise and exact annotations and may employ a layer concept. The method and system 1 may be used for private consumer purposes as well as for industrial applications. Compared with current conventional georeferenced platform options, the system 1 provides more precise and offer more features like backend and on-site authoring, industrial IoT integration, real-time update and modification. In an embodiment, the augmented reality bubbles ARBs are not based on geographical location but surround a specific geometrically recognizable object that may be at a fixed location but may also be movable in the real-world environment. An example for an object OBJ with a fixed location is a production machine or any kind of machine within a factory. An example for a movable object is for example a locomotive of a train. In an embodiment, the system 1 includes an augmented reality client device 3 that supports some form of object recognition and tracking (e.g., as available in ARKit 2). Just as the SLAM world map for georeferenced augmented reality bubbles is stored in the database 6 of the server 4, a visual and geometric description of the object (object tracking description) may be stored in the database 6 of the server 4.

Rather than performing an initial search for potential matching augmented reality bubbles based on a GPS query and geolocation, the augmented reality client device 3 may perform an image-based search from a camera image to identify which relevant objects are in the field of view FoV of the camera 7 and may then load the tracking descriptions from the server 4 of the system 1.

This may be made more efficient if additional information is available as to which objects OBJ may be found at which locations. For example, if there is a system that keeps track of which locomotive is at which GPS position, then the initial query Q to the server 4 that is based on the not accurate geolocation (GPS position) would return not only the SLAM map for the geographic augmented reality bubble ARB, but also an object tracking description of the locomotives of mobile objects that are currently in the specified area.

In an embodiment, a user U may then be able to view and edit digital layers L that belong to different augmented reality bubbles ARBs simultaneously, just as different layers are displayed for a single augmented reality bubble. For example, the user U may see both the annotations ANN that are related to train tracks and annotations ANN that are related to the moving object (locomotive) at the same time.

If an object is moving and is tracked e.g., by a GPS sensor, then its object-based augmented reality bubble ARB does move along with the moving object. Application examples for such a moving object include full or partial autonomous vehicles in factories that inform via annotations (AR holograms, symbols, text or figures) about their current work order or work activity. Further, they may indicate that they have room for additional occupants in regards to their target destination or may provide information about social and/or industrial issues.

Incoming trains TR in a railway station TR-S may provide augmented reality annotations about their route, time schedule and connection options to users.

Users may also provide information to other users. For example, a construction worker may inform another user U about their team membership and status of current workflow. For example, external site visitors may inform users U about their access rights to the industrial plant or site in a social context about their social status and interests.

In an embodiment of the system 1, object type bubbles and object example bubbles may be provided. In this embodiment, there exists augmented reality bubbles ARBs that are based around object types (e.g., all Vectron locomotives) and around particular object examples (e.g., locomotive number 12345). Information or annotations from both of these kinds of augmented reality bubbles may be displayed simultaneously at different logical layers L. This may be for example useful for distinguishing between general repair instructions and specific repair histories.

The system 1 may include also digital layers L that are not structured into augmented reality bubbles but simply process data from geographic systems, while other logical layers L are structured into augmented reality bubbles. Further, augmented reality bubbles ARBs may not be structured into digital layers L at all, but simply have all the augmented reality annotations in a flat structure.

Another variant of the system 1 includes the possibility to create content remotely, in virtual reality VR, or in a 3D modeling program and to place that content into the three-dimensional space virtually. Further variants may include to integrate VR and/or AR options. For example, an option to go to any GPS location in a VR equipment and to display the augmented reality bubble ARB content completely in VR, thereby increasing the view and possible viewing options. This application might be most relevant when client devices 3 converge VR and AR and are able to process both.

The system 1 may be integrated with other authoring systems. This provides for automatic creation and update of georeferenced augmented reality content by authoring a content within an established design tool or database such as NX tools or Teamcenter.

Further, with the system 1, innovative visualizations may be included such as X-ray features of holograms providing specific access e.g., to CAD models in a backend server. A mode of display for selection of layers L on site may be provided such as a virtual game card stack. The system 1 may be combined with other systems used for digital service and digital commissioning. It may be also combined with sales systems on an IoT platform such as MindSphere for visualization options of collected data. The augmented reality platform may be integrated into artificial intelligence and analytic applications. For example, a safety zone may be defined by taking into account the level of voltage in an electrical system or a pressure in a given tank. An augmented reality bubble ARB may include a size or diameter corresponding approximately to the size of a room or area, e.g., a diameter of approximately 10 meters. The size of the augmented reality bubble ARB corresponds to the size (file size) of the downloaded accurate local feature map thereby covering the respective zone or area. In an embodiment, the sphere of the augmented reality bubble ARB is also displayed in augmented reality AR to the user U via the display of the user interface 11. Accordingly, the user U has the possibility to see when the user moves from one augmented reality bubble to another augmented reality bubble. In a further embodiment, a user U may from one ARB to the next ARB seamlessly without noticing that the user changed from the first ARB to a second ARB.

Metadata of the ARBs may be displayed as well (e.g., creation time, user having created the ARB, etc.).

The method and system 1 provide a wide variety of possible use cases. For example, a machine commissioning, service and maintenance relevant information like the type of material, parameters, etc. may be provided upfront and/or annotated persistently during the commissioning, service and maintenance activities.

Further, construction sites may be digitally built on their later locations in real time during a design process by combining three-dimensional models and information with georeferenced data. This enables improved on-site design and planning discussions, verification of installation, clash detection and improved efficiency during construction and/or installation.

The system 1 provides ease of operation. For example, live data feeds from machines may be provided and integrated. Charts of MindSphere data may be made available anytime, anywhere in any required form via augmented reality AR.

Further, safety-relevant features and areas may be provided. It is possible to provide an update in real time according to performance data, e.g., of the MindSphere and/or SCADA system.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

While the present invention has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A method for providing annotations related to a location or related to an object in augmented reality, the method comprising:
retrieving by a client device of a user a candidate list of available augmented reality bubbles for the location, the object, or the location and the object in response to a query based on a geolocation of the client device, on user information data, or on the geolocation and the user information data;
selecting at least one augmented reality bubble from the retrieved candidate list of available augmented reality bubbles;
loading by the client device from a database a local map and a set of annotations for each selected augmented reality bubble; and
accurate tracking of the client device within the selected augmented reality bubble using the loaded local map of the respective augmented reality bubble to provide annotations in augmented reality at positions of the tracked client device.

2. The method of claim 1 wherein the at least one augmented reality bubble is selected from the retrieved candidate list automatically by:
capturing images, sounds, or images and sounds of the client device's environment,
comparing tags for the captured images captured sounds, or captured images and sounds with one or more predefined bubble identification tags associated with the at least one augmented reality bubbles, ARB, of the retrieved candidate list, and
determining one or more relevant augmented reality bubbles of the retrieved candidate list as a function of the comparison results or in response to a user command input via a user interface of the client device comprising a bubble name of a selected augmented reality bubble.

3. The method of claim 1, wherein the local map loaded by the client device comprises a local feature map of an environment of the selected augmented reality bubble or a CAD model of an object within the selected augment-ed reality bubble.

4. The method according of claim 1, to wherein the geolocation of the client device (3) is detected by a geolocation detection unit (12) of the client device configured determine the location of the client device in response to signals received by the geolocation detection unit from external signal sources including GPS satellites, WiFi stations, or GPS satellites and WiFi stations.

5. The method of claim 1, wherein the annotations at the tracked current position of the client device are output by a user interface of the client device.

6. The method of claim 1, wherein the annotations comprise static annotations including at least one of text annotations, acoustic annotations, or visual annotations related to a location or related to a physical object.

7. The method of claim 1, wherein the annotations comprise static annotations including at least one of text annotations, acoustic annotations, or visual annotations related to the augmented reality bubble.

8. The method of claim 1, wherein the annotations comprise links to sources providing static annotations, dynamic live annotations including data streams, or static annotations and dynamic live annotations including data streams.

9. The method of claim 1, wherein the annotations are associated with different digital annotation layers selectable, filtered, or selectable and filtered according to user information data including user access rights, user tasks, or user access rights and user tasks.

10. The method of claim 9, wherein the layers of which the respective annotations are displayed are prioritized according to a rating that is determined by one or more users or by an algorithm.

11. The method of claim 1, wherein each augmented reality bubble is represented by an augmented reality bubble dataset stored in a database of a platform,
wherein the augmented reality bubble dataset comprises:
a bubble name of the augmented reality bubble;
an anchor point attached to a location, the object, or the location and the object and including global coordinates of a global coordinate system;
a local spatial map including within a sphere of the augmented reality bubble tracking data for accurate tracking of client devices within the sphere and having local co-ordinates of a local coordinate system around the anchor point of said augmented reality bubble;
annotations related to locations, physical objects, or locations and physical objects within the sphere of the augmented reality bubble; and
bubble identification tags configured to identify the augmented reality bubble by comparison with extracted tags.

12. The method of claim 11 wherein the bubble identification tags of the augmented reality bubble dataset comprise detectable features within the sphere of the augmented reality bubble including at least one of textual features, acoustic features or visual features within an environment of the augmented reality bubble's sphere.

13. The method of claim 1, wherein images, sounds, or images and sounds of the device's environment are captured by one or more sensors of the client device and processed by a tag recognition algorithm or by a trained neural network to classify the images, counds, or images, and sounds and to extract tags for comparison with predefined bubble identification tags.

14. The method of claim 1, wherein two or more augmented reality bubbles are pooled together in one meta augmented reality bubble and the two or more augmented reality bubbles form part of the candidate list.

15. The method of claim 1 wherein one of the available augmented reality bubbles is linked to a position of a device of the user.

16. The method of claim 1, wherein the query is input via a user interface of the client device and supplied via a network to a server including a search engine that in response to a received query determines augmented reality bubbles available at the geolocation of the client device and returns the candidate list of available augmented reality bubbles to the client device.

17. The method of claim 16 wherein the client device further transmits sensor data to the server when transmitting the geolocation to the server.

18. The method of claim 1, wherein the accurate tracking of the client device within a sphere of a selected augmented reality bubble using the loaded local map of the respective augmented reality bubble is based on low level features extracted from images, sounds, or images and sounds captured by one or more sensors of the client device.

19. The method of claim 1, wherein the annotations related to a location, to a physical object, or to the location and to the physical object are created, edited, or assigned to specific digital layers by a user by a user interface of the client device of the respective user.

20. The method of claim 19, wherein the physical object is located at a fixed locations in a real-world environment or comprises a mobile object that is movable in the real-world environment and including a variable location.

21. A system for providing annotations related to locations, to object, or to locations and objects in augmented reality the system comprising:
one or more client devices connected via a network to a server;
the server configured to retrieve in response to a query from a querying client device of a user, a candidate list of available augmented reality bubbles based on an geolocation of the querying client device, user information data, or the geolocation and user information data, the server further configured to return the retrieved candidate list to the querying client device of the user for selection of at least one augmented reality bubble from the returned candidate list;
wherein a local map and a set of annotations for each selected augmented reality bubble is loaded from a database of the server by the client device used for tracking of the client device within the selected augmented reality bubble and to provide in augmented reality annotations at positions of the tracked client device.
